(19) United States
(12) Patent Application Publication
(10) Pub. No.: US 2024/0233235 A9
(43) Pub. Date: Jul. 11, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: SHINICHI UEMURA, Kanagawa (JP)

(21) Appl. No.: 18/488,711

(22) Filed: Oct. 17, 2023

(30) Foreign Application Priority Data
Oct. 24, 2022 (JP) 2022-170216

(51) Int. Cl. G06T 15/00; G06V 10/44; G06V 10/74; H04N 13/117; H04N 13/383

(52) U.S. Cl. CPC G06T 15/00; G06V 10/44; G06V 10/761; H04N 13/117; H04N 13/383

(57) ABSTRACT

An image processing apparatus includes one or more memories storing instructions, and one or more processors that execute the instructions to: acquire a plurality of images captured by a plurality of imaging apparatuses, and a first virtual viewpoint image generated based on the plurality of images, evaluate the first virtual viewpoint image based on a feature point of an image captured by an imaging apparatus imaging an object included in the first virtual viewpoint image among the plurality of imaging apparatuses, and a feature point of a second virtual viewpoint image corresponding to a viewpoint same as a viewpoint of the imaging apparatus imaging the object, and perform control for displaying the first viewpoint image and information indicating an evaluation result of the first virtual viewpoint image.

### BACKGROUND OF THE DISCLOSURE

### Field of the Disclosure

The present disclosure relates to a technique for generating a virtual viewpoint image from a three-dimensional model.

### Description of the Related Art

A technique for generating a virtual viewpoint image viewed from a designated virtual viewpoint by using a plurality of images captured by a plurality of imaging apparatuses has attracted attention. Japanese Patent Application Laid-Open No. 2015-45920 discusses a method of imaging an object by a plurality of imaging apparatuses installed at different positions, and generating a virtual viewpoint image using a three-dimensional shape of the object estimated from captured images acquired by the plurality of imaging apparatuses.

However, the method cannot provide digital content of the virtual viewpoint image enabling image quality of the virtual viewpoint image to be easily grasped.

### SUMMARY OF THE DISCLOSURE

The present disclosure is directed to a technique for easily grasping the image quality of the virtual viewpoint image.

According to an aspect of the present disclosure, an image processing apparatus includes one or more memories storing instructions, and one or more processors that execute the instructions to: acquire a plurality of images captured by a plurality of imaging apparatuses, and a first virtual viewpoint image generated based on the plurality of images, evaluate the first virtual viewpoint image based on a feature point of an image captured by an imaging apparatus imaging an object included in the first virtual viewpoint image among the plurality of imaging apparatuses, and a feature point of a second virtual viewpoint image corresponding to a viewpoint same as a viewpoint of the imaging apparatus imaging the object, and perform control for displaying the first viewpoint image and information indicating an evaluation result of the first virtual viewpoint image.

Further features of the present disclosure will become apparent from the following description of exemplary embodiments with reference to the attached drawings.

### BRIEF DESCRIPTION OF THE DRAWINGS

FIG. 1 is a diagram illustrating an apparatus configuration of an image processing apparatus according to one or more aspects of the present disclosure.

FIG. 2 is a diagram illustrating a hardware configuration of the image processing apparatus according to one or more aspects of the present disclosure.

FIG. 3 is a diagram illustrating a configuration of a content generation unit according to one or more aspects of the present disclosure.

FIG. 4 is a diagram illustrating content generated by the content generation unit according to one or more aspects of the present disclosure.

FIG. 5 is a flowchart illustrating an operation flow of the image processing apparatus according to one or more aspects of the present disclosure.

FIG. 6 is a diagram illustrating a configuration of the content generation unit according to one or more aspects of the present disclosure.

FIG. 7 is a flowchart illustrating an operation flow of an image processing apparatus according to one or more aspects of the present disclosure.

### DESCRIPTION OF THE EMBODIMENTS

Some exemplary embodiments of the present disclosure are described below with reference to drawings. However, the present disclosure is not limited to the exemplary embodiments described below. In the drawings, the same members or elements are denoted by the same reference numerals, and repetitive description is omitted or simplified.

### <Outline of Virtual Viewpoint Image Generation Function in Image Processing Apparatus>

An image processing apparatus according to a first exemplary embodiment generates a virtual viewpoint image viewed from a designated virtual viewpoint based on captured images acquired from different directions by a plurality of imaging apparatuses (cameras), states of the imaging apparatuses, and the designated virtual viewpoint. Further, the image processing apparatus displays the virtual viewpoint image on a surface of a virtual stereoscopic image. Each of the imaging apparatuses may include not only the camera but also a function unit configured to perform image processing. Further, each of the imaging apparatuses may include a sensor acquiring distance information, in addition to the camera.

The plurality of imaging apparatuses (hereinafter referred to as the plurality of cameras) images an imaging area from the plurality of directions. The imaging area is, for example, an area including a field of a stadium and an area surrounded by an optional height. The imaging area may correspond to a three-dimensional space where a three-dimensional shape of an object is estimated as described above. The three-dimensional space may be the whole or a part of the imaging area. Further, the imaging area may be a concert hall, an imaging studio, or the like.

The plurality of cameras is installed at different positions in the different directions (in different orientations) so as to surround the imaging area, and performs imaging in synchronization with each other. The plurality of cameras needs not be installed over the entire circumference of the imaging area, and may be installed only in some of the directions of the imaging area depending on limitation of installation positions and the like. The number of cameras is not limited. For example, in a case where the imaging area is a rugby field, about several tens to several hundreds of cameras may be installed around the field.

Further, the plurality of cameras may include cameras different in angle of view, for example, a telephoto camera and a wide-angle camera. For example, if a telephoto camera is used to image a player at a high resolution, it is possible to improve resolution of a generated virtual viewpoint image. Further, in a case of a ball game, a moving range of a ball is wide. If a wide-angle camera is used in imaging, the number of cameras used can be reduced. Further, if imaging is performed by combining the imaging areas of a wide-angle camera and a telephoto camera, it is possible to increase flexibility of installation positions of the cameras. The cameras are synchronized at a common time, and imaging time information is added to each frame of the captured image.

The virtual viewpoint image is also called a free viewpoint image, and the user can monitor an image corresponding to a viewpoint freely (optionally) designated by the user. For example, in a case where the user monitors an image corresponding to a viewpoint selected by the user from a plurality of limited viewpoint candidates, the image is also included in the virtual viewpoint image. The virtual viewpoint may be designated by user operation, or may be automatically designated by artificial intelligence (AI) based on a result of image analysis or the like. The virtual viewpoint image may be a moving image or a still image.

Virtual viewpoint information used for generation of the virtual viewpoint image is information including a position and a direction (orientation) of the virtual viewpoint, and an angle of view (focal length). More specifically, the virtual viewpoint information includes parameters indicating a three-dimensional position of the virtual viewpoint, parameters indicating directions (line-of-sight directions) from the virtual viewpoint in a pan direction, a tilt direction, and a roll direction, and focal length information. However, the content of the virtual viewpoint information is not limited to the above-described content.

The virtual viewpoint information may include parameters for each of the plurality of frames. In other words, the virtual viewpoint information may be information including parameters corresponding to each of the plurality of frames constituting the moving image of the virtual viewpoint image, and indicating the position and the direction of the virtual viewpoint at each of a plurality of continuous time points.

The virtual viewpoint image is generated by, for example, the following method. First, a plurality of camera images is acquired by imaging an object from different directions by the plurality of cameras. Next, from each of the plurality of camera images, a foreground image obtained by extracting a foreground area corresponding to the object such as a person and a ball, and a background image obtained by extracting a background area other than the foreground area are acquired. The foreground image and the background image each include texture information (e.g., color information).

Further, a foreground model indicating a three-dimensional shape of the object and texture data for coloring the foreground model are generated based on the foreground image. In addition, texture data for coloring a background model indicating a three-dimensional shape of the background such as a field is generated based on the background image. Thereafter, the respective pieces of texture data are mapped to the foreground model and the background model, and rendering is performed based on the virtual viewpoint indicated by the virtual viewpoint information. As a result, the virtual viewpoint image is generated.

However, the method of generating a virtual viewpoint image is not limited thereto, and various methods, for example, a method of generating a virtual viewpoint image by performing projective transformation on captured images without using the foreground model and the background model can be used.

The foreground image is an image obtained by extracting an area of the object (foreground area) from each of the captured images acquired by the cameras. The object extracted as the foreground area indicates a dynamic object (dynamic body) in motion, that can change in absolute position or shape in a case where imaging is performed from the same direction in a time series. Examples of the object include a person such as a player and a referee in a field where a game takes place, and a ball as well as a person in a case of a ball game. In addition, in a case of a concert and entertainment, a singer, a plyer, a performer, a master of ceremony, or the like is the object of the foreground.

The background image is an image of an area (background area) at least different from the object as the foreground. More specifically, the background image is an image in a state where the object as the foreground is removed from the captured image. In addition, in the case where imaging is performed from the same direction in a time series, the background indicates a stationary imaging object or an imaging object continuously maintained in a state close to a stationary state.

Examples of such an imaging object include a stage in a concert, a stadium where an event such as a game takes place, a structure such as a goal used in a ball game, and a field. The background is an area at least different from the object as the foreground. Another object in addition to the object and the background may be included as an imaging object in the capture image.

### <Description of Apparatus Configuration of Image Processing Apparatus>

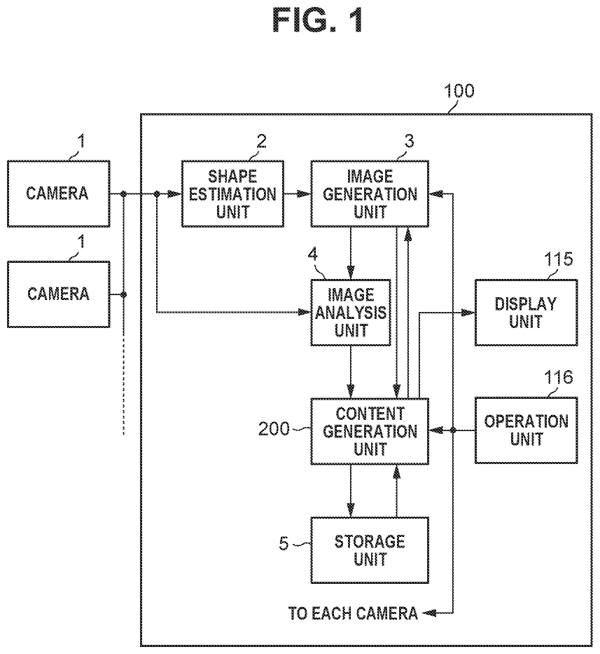

FIG. 1 is a diagram illustrating an image processing apparatus 100 according to the present exemplary embodiment. Some of functional blocks illustrated in FIG. 1 are realized by causing a computer included in the image processing apparatus 100 to execute computer programs stored in a memory as a storage medium. However, some or all of the functional blocks may be realized by hardware. As the hardware, a dedicated circuit (application specific integrated circuits (ASIC)), or a processor (reconfigurable processor or digital signal processor (DSP)) can be used.

The functional blocks of the image processing apparatus 100 may not incorporated in the same housing and may be included in different apparatuses connected to each other on a signal path. The image processing apparatus 100 is connected to a plurality of cameras 1. Further, the image processing apparatus 100 includes a shape estimation unit 2, an image generation unit 3, an image analysis unit 4, a content generation unit 200, a storage unit 5, a display unit 115, and an operation unit 116.

The shape estimation unit 2 is connected to the plurality of cameras 1 and the image generation unit 3. The display unit 115 is connected to the content generation unit 200. The functional blocks may be mounted on different apparatuses, or all or some of the functional blocks may be mounted on the same apparatus.

The plurality of cameras 1 is disposed at different positions around a stage in a concert or the like, a stadium where an event such as a game takes place, a structure such as a goal used in a ball game, a field, and the like, and the plurality of cameras 1 performs imaging from respective different viewpoints. Further, each of the cameras 1 has an identification number (camera number) for identification of each of the cameras. Each of the cameras 1 may have a function of extracting the foreground image from the captured image and other functions, and may include hardware (circuit, device, etc.) for implementing the functions. The camera number may be set based on an installation position of each of the cameras 1, or may be set based on the other reference.

The image processing apparatus 100 may be installed within the venue where the cameras 1 are disposed, or may be installed outside the venue, for example, a broadcasting station outside the venue. The image processing apparatus 100 is connected to the cameras 1 via a network.

The shape estimation unit 2 acquires images from the plurality of cameras 1. Further, the shape estimation unit 2 estimates a three-dimensional shape of an object based on the images acquired from the plurality of cameras 1. More specifically, the shape estimation unit 2 generates three-dimensional shape data represented by a well-known representation method. The three-dimensional shape data can be point-group data consisting of points, mesh data consisting of polygons, or voxel data consisting of voxels.

The image generation unit 3 can acquire information indicating a position and an orientation of the three-dimensional shape data on the object from the shape estimation unit 2, and generate a virtual viewpoint image including a two-dimensional shape of the object represented in a case where the three-dimensional shape of the object is viewed from a virtual viewpoint. In addition, to generate the virtual viewpoint image, the image generation unit 3 can receive designation of virtual viewpoint information (a position of the virtual viewpoint, a line-of-sight direction from the virtual viewpoint, etc.) from the user, and generate the virtual viewpoint image based on the virtual viewpoint information. The image generation unit 3 functions as an acquisition unit for generating the virtual viewpoint image based on the plurality of images acquired from the plurality of cameras.

The image analysis unit 4 can acquire the captured images and camera information from the cameras 1, acquire the virtual viewpoint image and various kinds of information at the time of generation of the virtual viewpoint image from the image generation unit 3, thereby generating quality information on the virtual viewpoint image from the acquired images and the acquired information. The quality information is information indicating image quality of the virtual viewpoint image, for example, information about resolution, information indicating accuracy of a texture, information indicating accuracy of a shape of the foreground, and information indicating characteristics of the method of generating the virtual viewpoint image.

The information about resolution described above is a numerical value relating to resolution of each camera and resolution of each voxel. The numerical value relating to the resolution of each camera indicates an imaging range of the object per one pixel, is represented in units of mm/pix, and is acquired from each camera 1. The numerical value relating to the resolution of each voxel indicates a representation range of the object per one voxel, is represented in units of mm/voxel, and is defined as a parameter in the image processing apparatus. As these numerical values are smaller, the shape and the texture of the foreground are more finely represented, and the image quality is accordingly higher.

The information indicating accuracy of a texture described above is a numerical value indicating a degree of approximation of the texture rendered on the foreground model to that of an original captured image. An example is described below. The image of the foreground model after rendering tends to be an image closer to the captured object as the number of cameras referred in rendering the texture (number of textures to be referred) is larger. Thus, the number of cameras is used as an index indicating the degree of approximation. The number of cameras referred is different depending on an element (mesh or voxels) that forms a surface of the foreground model, so that an average value of the numbers of cameras referred in all the elements is calculated. Further, since the number of cameras referred is also different for each frame, an average value of the above-described calculation values in all the frames is calculated. The calculated value is used as the information indicating accuracy of a texture.

The information indicating accuracy of the shape of the foreground described above is a numerical value indicating a degree of approximation of an outline of the foreground model to the original captured image. An example is described below. A similarity obtained by feature point matching between “an image captured by a camera 1” and “a virtual viewpoint image viewed from the same viewpoint as the camera 1” is used as an index indicating the above-described degree of approximation. The two images capture the same object, and the object is included in the virtual viewpoint image associated with digital content and appears in the virtual viewpoint image for the longest time. Since the positions of the viewpoints are the same, the texture rendered on the foreground model is substantially equal to that of the foreground image acquired from the image captured by the camera 1. Thus, the above-described similarity is influenced by difference in shape of the outline that is a factor other than the texture. For example, in a case where a hole or chipping occurs in the foreground model, a feature point of a portion where the hole or the chipping occurs cannot be detected. Thus, the similarity is calculated to be low. Further, since the similarity is different for each frame, an average value of the similarities of all the frames is calculated. The calculated value is used as the information indicating accuracy of the shape of the foreground.

The information indicating the characteristics of the method of generating the virtual viewpoint image described above includes information on the apparatus that generates the virtual viewpoint image and name and version information on an algorithm. Characteristics of the quality of the virtual viewpoint image can be grasped from the algorithm and the version information.

The quality information is not limited to the above-described information, and any information relating to the quality of the virtual viewpoint image can be used. For example, the quality information may be information based on subjective evaluation by an expert. In the present exemplary embodiment, among the above-described pieces of information, a piece of information to be displayed on the digital content is selected and displayed.

The above-described quality information and the virtual viewpoint image are transmitted to the content generation unit 200. The content generation unit 200 generates, for example, stereoscopic digital content as described below. In the present exemplary embodiment, the digital content refers to a three-dimensional object including the virtual viewpoint image.

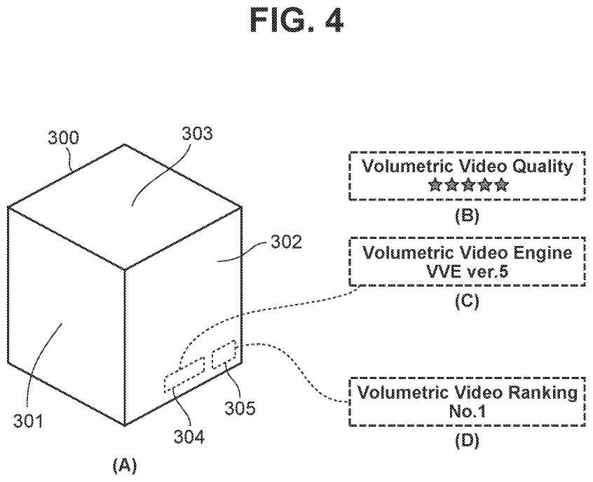

The digital content will be described in detail below with reference to FIG. 4. The digital content including the virtual viewpoint image that is generated by the content generation unit 200 is output to the display unit 115. The content generation unit 200 can directly receive images from the plurality of cameras 1, and supply the images of the respective cameras to the display unit 115. In addition, the content generation unit 200 can switch surfaces of the stereoscopic digital content where the images of the respective cameras, the virtual viewpoint image, and the image quality information are displayed, based on an instruction from the operation unit 116.

The display unit 115 includes a liquid crystal display, a light-emitting diode, and the like, acquires the digital content including the virtual viewpoint image from the content generation unit 200, and displays the digital content. Further, the display unit 115 displays a graphical user interface (GUI) for the user to operate each of the cameras 1.

The operation unit 116 includes a joystick, a jog dial, a touch panel, a keyboard, and a mouse, and the operation unit 116 is used by the user to operate the cameras 1 and the like.

In addition, the operation unit 116 is used by the user to select an image and quality information on the image to be displayed on the surfaces of the digital content (stereoscopic image) generated by the content generation unit 200. Further, the position and the orientation of a virtual viewpoint for generating the virtual viewpoint image by the image generation unit 3 can be designated through the operation unit 116.

The storage unit 5 includes a memory storing the digital content generated by the content generation unit 200, the virtual viewpoint image, the camera images, and the like. The storage unit 5 may include a detachable recording medium that can be attached to and detached from the storage unit 5. The detachable recording medium can record, for example, a plurality of camera images captured at another venue or another sports scene, virtual viewpoint images generated using the plurality of camera images, digital content generated by combining the virtual viewpoint images, and the like.

Further, the storage unit 5 may store a plurality of camera images downloaded from an external server and the like via a network, virtual viewpoint images generated using the plurality of camera images, digital content generated by combining the virtual viewpoint images, and the like. Further, the camera images, the virtual viewpoint images, the digital content, and the like may be created by a third party.

### <Description of Hardware Configuration of Image Processing Apparatus>

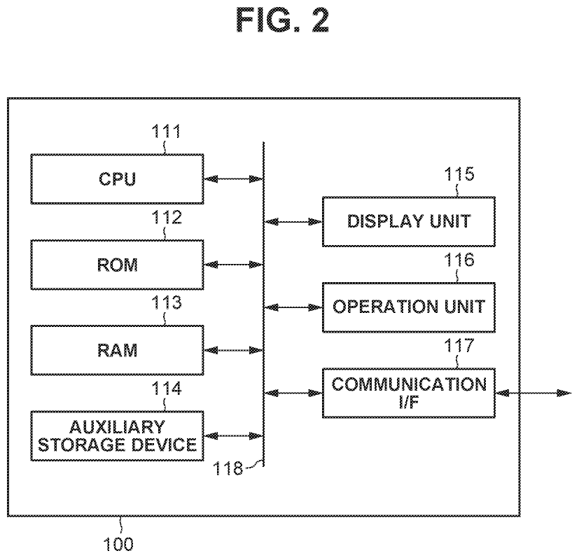

FIG. 2 is a diagram illustrating a hardware configuration of the image processing apparatus 100 according to the first exemplary embodiment. The hardware configuration of the image processing apparatus 100 is described with reference to FIG. 2.

The image processing apparatus 100 includes a central processing unit (CPU) 111, a read only memory (ROM) 112, a random access memory (RAM) 113, an auxiliary storage device 114, the display unit 115, the operation unit 116, a communication interface (I/F) 117, and a bus 118. The CPU 111 implements the functional blocks of the image processing apparatus 100 illustrated in FIG. 1 by controlling the whole of the image processing apparatus 100 using computer programs stored in the ROM 112, the RAM 113 or the auxiliary storage device 114.

The RAM 113 temporarily stores computer programs and data supplied from the auxiliary storage device 114, data supplied from an external device via the communication I/F 117, and the like. The auxiliary storage device 114 includes, for example, a hard disk drive, and stores various data such as image data, sound data, and digital content including a virtual viewpoint image from the content generation unit 200.

As described above, the display unit 115 displays digital content including a virtual viewpoint image, a GUI, and the like. As described above, the operation unit 116 receives operation input by the user and inputs various kinds of instructions to the CPU 111. The CPU 111 operates as a display control unit controlling the display unit 115 and as an operation control unit controlling the operation unit 116.

The communication I/F 117 is used for communication with an external apparatus (e.g., cameras 1 and external server) outside the image processing apparatus 100. For example, in a case where the image processing apparatus 100 is connected to the external apparatus by a cable, a communication cable is connected to the communication I/F 117. In a case where the image processing apparatus 100 has a function of wirelessly communicating with the external apparatus, the communication I/F 117 includes an antenna. The bus 118 connects the units of the image processing apparatus 100 to transmit information therebetween.

In the present exemplary embodiment, an example in which the display unit 115 and the operation unit 116 are internally included in the image processing apparatus 100 is described; however, at least one of the display unit 115 and the operation unit 116 may be provided as a separate device outside the image processing apparatus 100. The image processing apparatus 100 may have the form of, for example, a personal computer (PC) terminal.

### <Description of Configuration of Content Generation Unit 200>

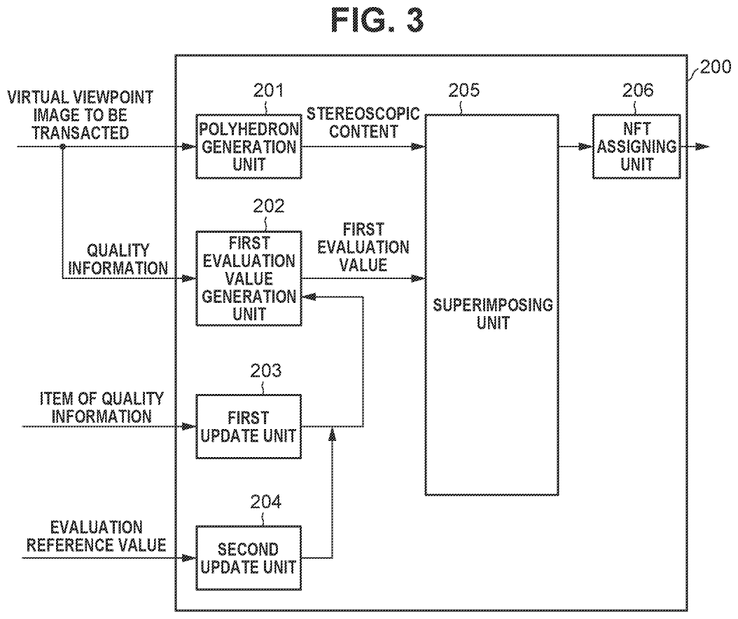

A configuration of the content generation unit 200 according to the first exemplary embodiment is described with reference to FIG. 3. The content generation unit 200 includes a polyhedron generation unit 201, a first evaluation value generation unit 202, a first update unit 203, a second update unit 204, a superimposing unit 205, and a non-fungible token (NFT) assigning unit 206.

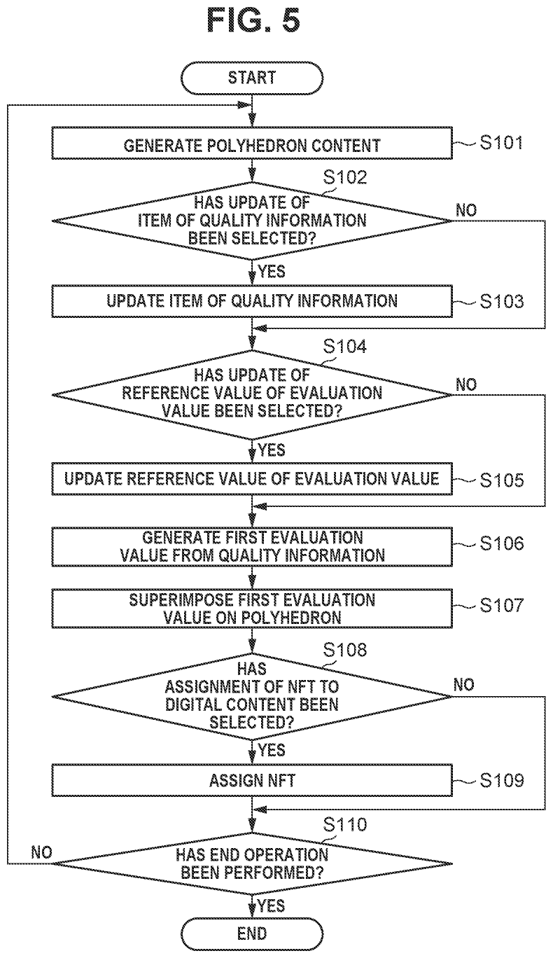

Next, an outline of each of the components is described. Details are described below in description with reference to a flowchart in FIG. 5.

The polyhedron generation unit 201 generates a polyhedron as stereoscopic digital content in which the virtual viewpoint image and the camera images are associated with surfaces of the polyhedron.

The first evaluation value generation unit 202 generates a first evaluation value using one or a plurality of pieces of quality information. The evaluation value is a value obtained by normalizing the quality information by an integer such that the evaluation value is easily understandable to the user.

The first update unit 203 updates a type of the quality information used when the first evaluation value generation unit 202 generates the evaluation value.

The second update unit 204 updates an evaluation reference value used when the first evaluation value generation unit 202 generates the evaluation value.

The superimposing unit 205 superimposes the first evaluation value generated by the first evaluation value generation unit 202, on the stereoscopic digital content generated by the polyhedron generation unit 201.

The non-fungible token (NFT) assigning unit 206 assigns an NFT to the stereoscopic digital content generated by the superimposing unit 205. The NFT is a token for issuance and distribution on a blockchain. Examples of a format of the NFT include token standards called ERC-721 and ERC-1155. The token is normally stored in association with a wallet managed by the user. In the present exemplary embodiment, the NFT is assigned to the digital content; however, the configuration is not limited thereto. The digital content assigned with the NFT is recorded in the blockchain in association with identifiers of the NFT and the digital content, and a user identification (ID) indicating an owner of the digital content. Further, the digital content has metadata outside the blockchain. A title, description, a uniform resource locator (URL), and the like of the content are stored in the metadata. In a case of a configuration in which the NFT is not assigned to the digital content, the NFT assigning unit 206 may not be provided. Further, the NFT assigning unit 206 may be provided in the external apparatus.

### <Description of Method for Superimposing Digital Content and Quality Information>

FIG. 4 is a diagram illustrating an example of the stereoscopic digital content generated by the content generation unit 200 according to the first exemplary embodiment. In the present exemplary embodiment, the digital content is a cube-shaped stereoscopic three-dimensional object displaying the virtual viewpoint image on a specific surface thereof; however, the digital content is not limited thereto.

A shape of the digital content may be a columnar shape or a sphere shape. In this case, the virtual viewpoint image is displayed in a specific area on a surface of the sphere, or is displayed inside of the column.

FIG. 5 is a flowchart illustrating an operation flow of the image processing apparatus 100 according to the first exemplary embodiment. Operation in each step of the flowchart in FIG. 5 is performed when the CPU 111 as a computer of the image processing apparatus 100 executes computer programs stored in the memory such as the ROM 112 and the auxiliary storage device 114. The image processing apparatus 100 starts processing when the operation unit 116 receives operation to start content creation from the user.

In step S101, the polyhedron generation unit 201 associates various kinds of images and information with surfaces of the stereoscopic digital content as illustrated by a left figure (A) in FIG. 4 under the control of the CPU 111. In the present exemplary embodiment, a surface on a left side is a first surface 301, a surface on a right side is a second surface 302, and a surface on an upper side is a third surface 303. First, a main camera image is associated with the first surface 301. The main camera image is an image selected for television broadcasting or the like among the plurality of images acquired from the plurality of cameras installed in a sports stadium. The main camera image is an image including a predetermined object in an angle of view. Next, as additional data, for example, data on a name of a player who has made a shot on goal, a name of a team that the player belongs to and a final game result is associated with the third surface 303. In a case where the NFT is assigned, data indicating rarity such as the number of issuances may be displayed as the additional data on the third surface 303. The number of issuances may be determined by the user generating the digital content using an image generation system, or may be automatically determined by the image generation system. Finally, the virtual viewpoint image is associated with the second surface 302. The virtual viewpoint image is a virtual viewpoint image that is captured at a viewpoint having a predetermined relationship with the first image and is acquired from the image generation unit 3. The viewpoint having a predetermined relationship is a viewpoint having a predetermined angular relationship or a predetermined positional relationship with the viewpoint of the main camera image. The first surface to the third surface can be optionally set in advance.

In step S102, the CPU 111 determines whether there is an update of the quality information. To perform the determination, the CPU 111 displays, for example, a GUI asking whether to update the type of the quality information for calculation of an evaluation value, and asking about the type of the quality information after update, on the display unit 115. In a case where the user selects “update” and inputs the type of the quality information after update (YES in step S102), the CPU 111 makes the determination based on the selection and the input type, and the processing proceeds to step S103. In a case where the user selects “not update” (NO in step S102), the processing proceeds to step S104.

In step S103, the first update unit 203 acquires the type of the quality information from the CPU 111, and transmits the type of the quality information to the first evaluation value generation unit 202. The first evaluation value generation unit 202 calculates the evaluation value based on the type.

In step S104, the CPU 111 determines whether there is an update of the reference value of the evaluation value. To perform the determination, the CPU 111 displays, for example, a GUI asking whether to update the reference value and asking about the reference value after update, on the display unit 115. In a case where the user selects “update” and inputs the reference value after update (YES in step S104), the CPU 111 makes the determination based on the selection and the input reference value, and the processing proceeds to step S105. In a case where the user selects “not update” (NO in step S104), the processing proceeds to step S106.

In step S105, the second update unit 204 acquires the reference value for evaluation from the CPU 111, and transmits the reference value for evaluation to the first evaluation value generation unit 202.

In step S106, the first evaluation value generation unit 202 generates the first evaluation value to be superimposed on digital content 300 as illustrated by the left figure (A) in FIG. 4. As an example of a generation method, an example in which the evaluation value is generated from the quality information, and an example in which the quality information itself is used as the evaluation value are described. In a case where the evaluation value is generated from the quality information, the first evaluation value generation unit 202 normalizes one or a plurality of pieces of quality information to a numerical value or numerical values easily understandable to the user. For example, a rectangle (B) in FIG. 4 illustrates an example in which the quality information is normalized by an integer of 5, and a numerical value is presented by star symbols. In this example, the quality information includes four pieces of information indicating the image quality of the virtual viewpoint image, such as the information about resolution, the information indicating accuracy of a texture, the information indicating accuracy of the shape of the foreground, and the information indicating characteristics of the method of generating the virtual viewpoint image. Equations for normalization are represented by an equation (1) and an equation (2). However, the equations described here are merely examples, and the calculation equations are not limited thereto. For example, calculation may be performed using one of the above-described four pieces of information as the quality information.

SUM=Pmax/Pact*α+Vmax/Vact*β+Tact/Tmax*γ+Fmax/Fact*Δ (1)

E=Round(SUM*N) (2)

In the equations, Pmax/Pact is an evaluation value of pixel resolution that is a real number up to 1.0, Pact is pixel resolution (mm/pix) in imaging, Pmax is a reference value (mm/pix) for evaluation. Vmax/Vact is an evaluation value of voxel resolution that is a real number up to 1.0, Vact is voxel resolution (voxel/pix), Vmax is a reference value (voxel/pix) for evaluation. Tact/Tmax is an evaluation value of accuracy of a texture that is a real number up to 1.0, Tact is a numerical value indicating accuracy of a texture, Tmax is a reference value for evaluation. Fmax/Fact is an evaluation value of accuracy of the shape of the foreground that is a real number up to 1.0, Fact is a numerical value indicating accuracy of the shape of the foreground, Fmax is a reference value for evaluation. Further, α, β, γ, and Δ are weighting factors of the respective evaluation values, a sum of these factors is a real number of 1.0. SUM is a sum of the weighted evaluation values and is a real number up to 1.0, E is an evaluation value that is obtained by normalizing the sum of the evaluation values by N and is to be superimposed on the digital content, and N is an integer for normalization. In the above-described equations, the four types of quality information are used for calculation of the evaluation value; however, the types can be changed by the first update unit 203. In addition, the reference values and the weighting factors used in the above-described equations can be changed by the second update unit 204.

A rectangular (C) in FIG. 4 illustrates a case where the quality information itself is used as the evaluation value. This is an example in which information indicating the apparatus that generates the virtual viewpoint image and the characteristics of the algorithm is displayed as the evaluation value. For example, by displaying a name and a version of the algorithm, it is possible to notify the user of the quality of the image. The evaluation value determined based on the above-described processing is finalized as a final evaluation value, that is, as an evaluation result, and superimposed on the virtual viewpoint image.

In step S107, the superimposing unit 205 associates the evaluation value with a position 304 on the second surface 302 in the figure (A) on the left side of FIG. 4, under the control of the CPU 111. To perform the association, for example, the second surface 302 is displayed on the display unit 115, and the display position is adjusted and determined by the operation unit 116. This makes it possible to superimpose and display the evaluation value on the virtual viewpoint image.

In step S108, The CPU 111 determines whether to assign the NFT to the digital content. To perform the determination, the CPU 111 displays, for example, a GUI asking whether to assign the NFT to the digital content, on the display unit 115. In a case where the user selects “assign” to assign the NFT (YES in step S108), the CPU 111 makes the determination based on the selection, and the processing proceeds to step S109. In a case where the user selects “not assign” (NO in step S108), the processing proceeds to step S110.

In step S109, the NFT assigning unit 206 assigns the NFT to the digital content and performs encryption of the NFT.

In step S110, the CPU 111 determines whether to end the flow of processing for generating the digital content illustrated in the figure (A) of FIG. 4. In a case where the user has not performed end operation using the operation unit 116 (NO in step S110), the processing returns to step S101, and the above-described processing is repeated. In a case where the user has performed the end operation (YES in step S110), the flow of processing in FIG. 5 ends. Even in a case where the user has not performed the end operation using the operation unit 116, the flow of processing may be automatically ended after a predetermined period (e.g., 30 minutes) elapses from the last operation performed on the operation unit 116.

As described above, according to the present exemplary embodiment, it is possible to provide the image processing apparatus that allows the user to easily grasp the image quality of the virtual viewpoint image.

In the present exemplary embodiment, the image processing apparatus 100 may be installed in a broadcasting station or the like, and the stereoscopic digital content 300 illustrated in FIG. 4 may be created and broadcasted, or may be distributed through the Internet. At this time, the NFT can be assigned to the digital content 300. In other words, to improve a property value, rarity can be given to the digital content by, for example, limiting the number of pieces of content to be distributed and managing the contents by serial numbers. As described above, the NFT is a token for issuance and distribution on a blockchain. Examples of a format of the NFT include token standards called ERC-721 and ERC-1155. The token is normally stored in association with a wallet managed by the user.

In the first exemplary embodiment, the evaluation value is generated based on the predetermined reference value and is superimposed on the digital content. In a second exemplary embodiment, the evaluation value is compared with an evaluation value of another virtual viewpoint image, and a relative position (second evaluation value) is superimposed on the digital content. The second exemplary embodiment is described with reference to FIGS. 4, 6, and 7.

### <Description of Configuration of Content Generation Unit 200>

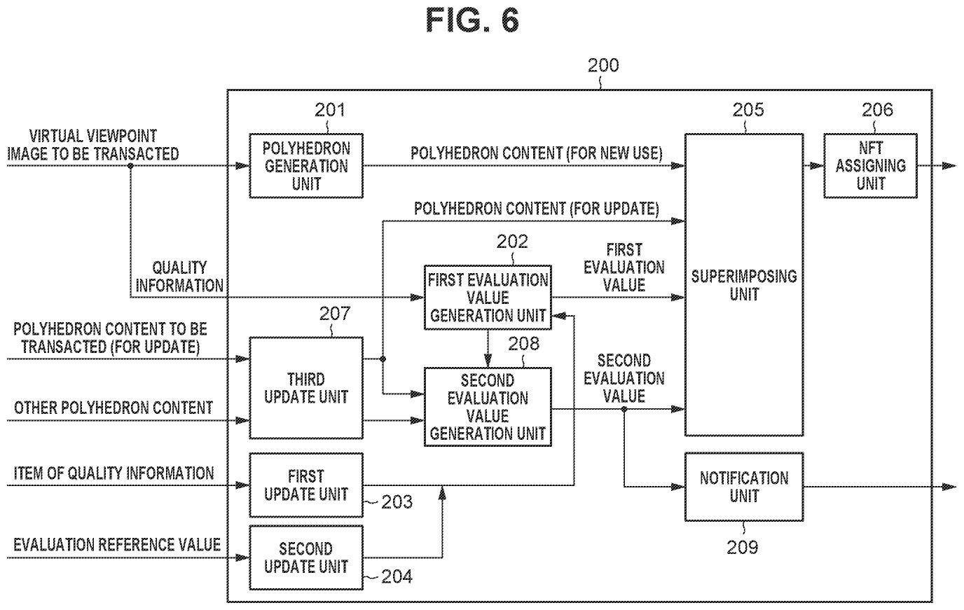

FIG. 6 is a diagram illustrating a configuration of the content generation unit 200 according to the second exemplary embodiment. The content generation unit 200 includes, in addition to the units 201 to 206 described in the first exemplary embodiment, a third update unit 207, a second evaluation value generation unit 208, and a notification unit 209.

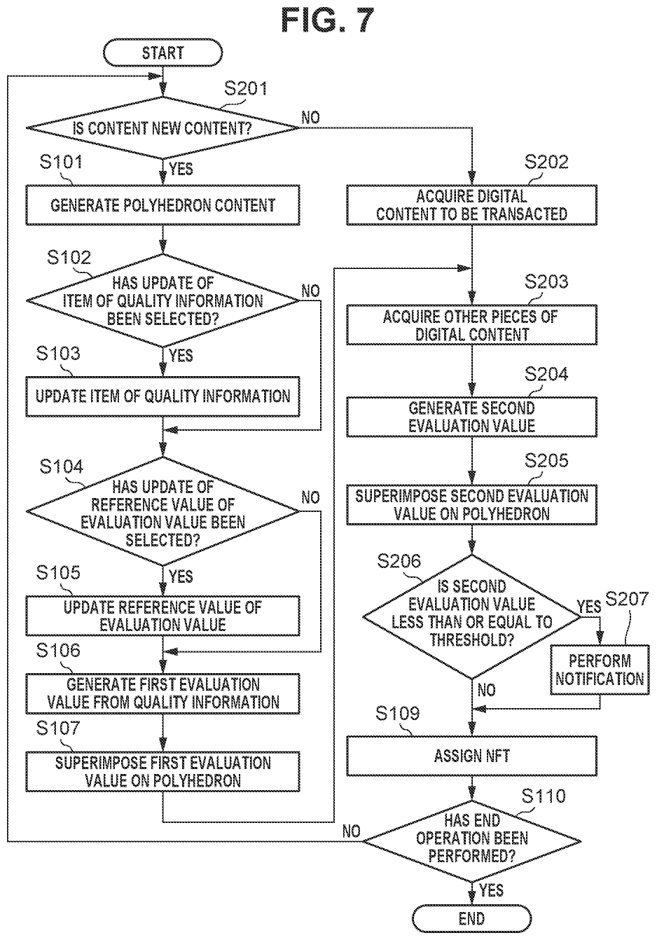

Next, an outline of each of the components is described. Details are described below in description with reference to a flowchart in FIG. 7.

The third update unit 207 acquires the already-created digital content to be transacted, and digital content of another virtual viewpoint image that is different from the digital content to be transacted, from the storage unit 5.

The second evaluation value generation unit 208 generates a second evaluation value by using the first evaluation value of the digital content to be transacted, and the first evaluation value acquired by the third update unit 207.

The notification unit 209 refers to the second evaluation value, and performs notification to the user via the display unit 115, depending on the second evaluation value.

FIG. 7 is a flowchart illustrating an operation flow of the image processing apparatus 100 and the content generation unit 200 according to the second exemplary embodiment.

Operation in each step of the flowchart in FIG. 7 is performed when the CPU 111 as a computer of the image processing apparatus 100 executes computer programs stored in the memory such as the ROM 112 and the auxiliary storage device 114.

In FIG. 7, processing in steps denoted by the same reference numerals (S101 to S107, S109 and S110) as in FIG. 5 is the same processing as in FIG. 5. Therefore, description of the steps is omitted.

The image processing apparatus 100 starts the processing based on any of the following two conditions. In a first condition, the image processing apparatus 100 starts the processing when the operation unit 116 receives operation to start creation of a new content from the user. In a second condition, the CPU 111 refers to the number of pieces of digital content stored in the storage unit at a predetermined cycle (e.g., several days to one month), and notifies the user of presence/absence of variation in the number via the display unit 115. Thereafter, the image processing apparatus 100 starts the processing when the operation unit 116 receives operation to start update of the existing content from the user.

In step S201, the CPU 111 determines whether the digital content to be transacted is new content or whether the digital content is to be updated due to variation in the number of pieces of content. To perform the determination, the CPU 111 displays, for example, a GUI asking whether the digital content is new content, on the display unit 115. In a case where the user selects “new content” (YES in step S201), the CPU 111 makes the determination based on the selection, and the processing proceeds to step S101. In a case where the user selects “update” (NO in step S201), the processing proceeds to step S202.

In step S202, the third update unit 207 acquires digital content to be updated from the storage unit 5.

In step S203, the third update unit 207 acquires pieces of digital content of a plurality of virtual viewpoint images that are different from the digital content to be transacted, from the storage unit 5.

In step S204, the second evaluation value generation unit 208 generates the second evaluation value to be superimposed on the digital content 300 illustrated in the figure (A) of FIG. 4 using the first evaluation values acquired from the digital content group acquired by the third update unit 207. The second valuation value is a relative position of the virtual viewpoint image to be transacted with respect to a certain parameter. The parameter is the number of all transaction images or the number of virtual viewpoint videos targeting either the same person or the same scene. The parameter may be set based on user operation. As a method of generating the second evaluation value, the first evaluation values of the virtual viewpoint images as the subjects of the parameter are sorted in ascending order, and a position of the first evaluation value of the digital content to be transacted is calculated as the second evaluation value. In other words, the evaluation values of all the transaction images and the evaluation value of the digital content to be transacted are compared to determine a rank order (comparison result) of the first evaluation value of the digital content to be transacted among all the transaction images, as the second evaluation value. The first evaluation values to be sorted are evaluation values before normalization represented by the equation (1) in the first exemplary embodiment.

In step S205, the superimposing unit 205 associates the evaluation value with a position 305 on the second surface 302 in the figure (A) of FIG. 4, under the control of the CPU 111. To perform the association, for example, the second surface 302 is displayed on the display unit 115, and the user adjusts and determines the display position using the operation unit 116. For example, a rectangle (D) in FIG. 4 illustrates an example of the second evaluation value.

In step S206, the notification unit 209 determines whether the second evaluation value is less than or equal to a threshold (e.g., N=10, worst 10). In a case where the second evaluation value is less than or equal to the threshold (YES in step S206), the processing proceeds to step S207. In a case where the second evaluation value is not less than or equal to the threshold (NO in step S206), the processing proceeds to step S109.

In step S207, the notification unit 209 notifies the user that the second evaluation value is less than or equal to the threshold via the display unit 115. The notification is to prompt the user to recreate a virtual viewpoint image, for example, in a case where the second evaluation value is less than or equal to the threshold in creation of the new content. For example, if the threshold is set to N=10, it can be determined that the image quality of the created new content is low, which can be a determination factor for determining to recreate a new virtual viewpoint image.

As described above, according to the present exemplary embodiment, it is possible to provide the image processing apparatus that allows the user to easily grasp the image quality of the virtual viewpoint image.

Although the present disclosure is described in detail above based on the plurality of exemplary embodiments, the present disclosure is not limited to the above-described exemplary embodiments, and various modifications can be made within the gist of the present disclosure and are not excluded from the scope of the present disclosure.

A part or all of the control in the present exemplary embodiment can be implemented by the process of supplying a computer program for implementing the functions of the above-described exemplary embodiments to an image processing system through a network or various kinds of storage media. Further, a computer (CPU, microprocessor unit (MPU), etc.) in the image processing system may read out and execute the program. In this case, the program and the storage medium storing the program constitutes the present disclosure.

### OTHER EMBODIMENTS

Embodiment(s) of the present DISCLOSURE can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-170216, filed Oct. 24, 2022, which is hereby incorporated by reference herein in its entirety.

What is claimed is:

1. An image processing apparatus,
one or more memories storing instructions; and
one or more processors that execute the instructions to:
acquire a plurality of images captured by a plurality of imaging apparatuses, and a first virtual viewpoint image generated based on the plurality of images;
evaluate the first virtual viewpoint image based on a feature point of an image captured by an imaging apparatus imaging an object included in the first virtual viewpoint image among the plurality of imaging apparatuses, and a feature point of a second virtual viewpoint image corresponding to a viewpoint same as a viewpoint of the imaging apparatus imaging the object; and
perform control for displaying the first viewpoint image and information indicating an evaluation result of the first virtual viewpoint image.

2. The image processing apparatus according to claim 1, wherein a position of a virtual viewpoint corresponding to the second virtual viewpoint image and a line-of-sight direction from the virtual viewpoint are same as a position and a line-of-sight direction of the imaging apparatus imaging the object.

3. The image processing apparatus according to claim 1, wherein the information indicating the evaluation result is a value obtained by dividing a similarity between the image captured by the imaging apparatus imaging the object included in the first virtual viewpoint image among the plurality of imaging apparatuses and the second virtual viewpoint image corresponding to the viewpoint same as the viewpoint of the imaging apparatus imaging the object by a reference value.

4. The image processing apparatus according to claim 3, wherein the similarity is generated from feature point matching between the image captured by the imaging apparatus imaging the object included in the first virtual viewpoint image among the plurality of imaging apparatuses and the second virtual viewpoint image corresponding to the viewpoint same as the viewpoint of the imaging apparatus imaging the object.

5. The image processing apparatus according to claim 3, wherein the reference value is set based on user operation.

6. The image processing apparatus according to claim 1, wherein the information indicating the evaluation result of the first virtual viewpoint image is superimposed on the first virtual viewpoint image.

7. The image processing apparatus according to claim 1, wherein the first virtual viewpoint image and the information indicating the evaluation result of the first virtual viewpoint image are displayed on a specific surface of a polyhedral three-dimensional object.

8. The image processing apparatus according to claim 7, wherein the polyhedral three-dimensional object is associated with a non-fungible token.

9. The image processing apparatus according to claim 1, wherein each of the first virtual viewpoint image and the second virtual viewpoint image is a moving image including a plurality of frames.

10. The image processing apparatus according to claim 1,
wherein each of the first virtual viewpoint image and the second virtual viewpoint image is a moving image including a plurality of frames, and
wherein the information indicating the evaluation result is a value obtained by averaging values obtained for the plurality of frames by dividing a similarity between the image captured by the imaging apparatus imaging the object included in the first virtual viewpoint image among the plurality of imaging apparatuses and the second virtual viewpoint image corresponding to the viewpoint same as the viewpoint of the imaging apparatus imaging the object by a reference value.

11. The image processing apparatus according to claim 1, wherein the one or more programs include further instructions to:
compare a plurality of virtual viewpoint images and the first virtual viewpoint image based on information indicating evaluation results of the plurality of virtual viewpoint images and the information indicating the evaluation result of the first virtual viewpoint image; and
generate a three-dimensional object on which the first virtual viewpoint image, the information indicating the evaluation result, and information indicating a comparison result are superimposed and displayed.

12. The image processing apparatus according to claim 11,
wherein the information indicating the evaluation result is a value obtained by dividing a similarity between the image captured by the imaging apparatus imaging the object included in the first virtual viewpoint image among the plurality of imaging apparatuses and the second virtual viewpoint image corresponding to the viewpoint same as the viewpoint of the imaging apparatus imaging the object by a reference value, and
wherein the information indicating the comparison result is a rank order when the information indicating the evaluation results of the plurality of virtual viewpoint images and the information indicating the evaluation result of the first virtual viewpoint image are sorted in order.

13. The image processing apparatus according to claim 12, wherein the one or more programs include further instructions to perform, in a case where the information indicating the comparison result is less than or equal to a threshold, control for displaying information indicating that the information indicating the comparison result is less than or equal to the threshold.

14. An image processing apparatus,
one or more memories storing instructions; and
one or more processors that execute the instructions to:
acquire a first virtual viewpoint image generated based on a plurality of images captured by a plurality of imaging apparatuses;
evaluate the first virtual viewpoint image based on a number of imaging apparatuses imaging an object included in the first virtual viewpoint image among the plurality of imaging apparatuses; and
perform control for displaying the first virtual viewpoint image and information indicating an evaluation result of the first virtual viewpoint image.

15. The image processing apparatus according to claim 14, wherein the larger the number of imaging apparatuses imaging the object, the higher evaluation on the first virtual viewpoint image.

16. An image processing method, comprising:
acquiring a plurality of images captured by a plurality of imaging apparatuses, and a first virtual viewpoint image generated based on the plurality of images;
evaluating the first viewpoint image based on a feature point of an image captured by an imaging apparatus imaging an object included in the first virtual viewpoint images among the plurality of imaging apparatuses, and a feature point of a second virtual viewpoint image corresponding to a viewpoint same as a viewpoint of the imaging apparatus imaging the object; and
performing control for displaying the first viewpoint image and information indicating an evaluation result of the first virtual viewpoint image.

17. A non-transitory computer readable storage medium storing a program executable by a computer to execute an image processing method comprising:
acquiring a plurality of images captured by a plurality of imaging apparatuses, and a first virtual viewpoint image
evaluating the first viewpoint image based on a feature point of an image captured by an imaging apparatus imaging an object included in the first virtual viewpoint images among the plurality of imaging apparatuses, and a feature point of a second virtual viewpoint image corresponding to a viewpoint same as a viewpoint of the imaging apparatus imaging the object; and
performing control for displaying the first viewpoint image and information indicating an evaluation result of the first virtual viewpoint image.
